(19) United States
(12) Patent Application Publication
(10) Pub. No.: US 2025/0222669 A1
(43) Pub. Date: Jul. 10, 2025

(54) TIRE BUILDING METHOD AND MECHANICAL DRUM

(71) Applicants: MESNAC CO., LTD, Qingdao, Shandong (CN); QINGDAO MESNAC MACHINERY & ELECTRIC ENGINEERING CO., LTD., Qingdao, Shandong (CN)

(72) Inventors: Bingzhen Guan, Qingdao, Shadong (CN); Yihang Yu, Qingdao, Shandong (CN); Xingrui Li, Qingdao, Shandong (CN); Yu Yang, Qingdao, Shandong (CN); Yi Wang, Qingdao, Shandong (CN)

(21) Appl. No.: 18/875,748

(22) PCT Filed: Jun. 16, 2023
(86) PCT No.: PCT/CN2023/100839

§ 371 Date: Dec. 17, 2024

(30) Foreign Application Priority Data
Jun. 17, 2022 (CN) 202210690246.0

(51) Int. Cl. B29D 30/32

(52) U.S. Cl. CPC B29D 30/32; B29D 2030/3257

(57) ABSTRACT

The present disclosure provides a tire building method and a mechanical drum. The tire building method includes: step S1: controlling an attaching mechanism to roll a bead filler to attach the bead filler to a tire carcass; step S2: while attaching the bead filler or during a process of attaching the bead filler, controlling a turn-up mechanism to roll a sidewall so as to attach the sidewall to the tire carcass. The tire building method according to the present disclosure solves problems of long time of building the tire and low efficiency of building the tire in the related art.

### CROSS-REFERENCE TO RELATED APPLICATION

The present disclosure claims a priority from Chinese patent application No. 202210690246.0 entitled “TIRE BUILDING METHOD AND MECHANICAL DRUM”, which is filed with CNIPA on Jun. 17, 2022, and the entire contents of which are incorporated herein by reference.

### TECHNICAL FIELD

The present disclosure relates to the field of rubber tires, and in particular to a tire building method and a mechanical drum.

### BACKGROUND

When the existing tires are turned-up built, they are mainly divided into mechanical drums and capsule drums based on the manner of attaching the sidewalls of tires. When the capsule drum is used to turn up the sidewalls of tires, the capsule is inflated to attach the sidewalls to the sides of a carcass of the tire, which can avoid a problem of indentations on the tire sides. However, the capsule drum has problems of cumbersome capsule replacement, high capsule cost, and poor tire bead building quality compared with the mechanical drum, resulting in a high defective tire rate and high costs.

For mechanical drums, although their cost is low, the existing tire building process includes a bead-filler attaching process, a tire-bead installing and turning up process, and other processes. Due to the structure of the current mechanical drum, the building process needs to be performed one by one. For example, the current turning up process needs to wait until the bead filler is completely attached to the tread before it can be performed. Otherwise, the movements between the various processes will interfere with each other, which makes the entire building process time-consuming and has low production efficiency, and is not suitable for rapid mass production.

### SUMMARY

The main purpose of the present disclosure is to provide a method for building a tire and a mechanical drum, so as to solve problems of long tire building time and low building efficiency in the related art.

In order to achieve the above-mentioned purpose, according to one aspect of the present disclosure, a method for building a tire is provided, which includes: step S1: controlling an attaching mechanism to roll a bead filler to attach the bead filler to a carcass of the tire; step S2: while attaching the bead filler or during a process of attaching the bead filler, controlling a turn-up mechanism to roll a sidewall so as to attach the sidewall to the carcass of the tire.

In an embodiment, the method for building a tire further includes step S3 after performing step S1, step S3: during a process of rolling, by the turn-up mechanism, the sidewall or after performing the step S2, controlling the attaching mechanism to roll the sidewall to attach the sidewall to the carcass of the tire, where the turn-up mechanism and the attaching mechanism roll different positions of the sidewall respectively.

In an embodiment, when performing the step S3, the two suspension arms are symmetrically arranged on the attaching mechanism to roll the sidewalls on both sides of the tire simultaneously.

In an embodiment, when performing the step S2, a lead screw assembly is driven to rotate by a motor so that a pressure roller assembly on the turn-up mechanism moves along a radial direction of the tire.

In an embodiment, when performing the step S2, the pressure roller assembly is driven by a limiting cylinder to press the sidewall of the tire, so that the pressure roller assembly always abuts against the sidewall during movement.

In an embodiment, when performing the step S2, a plurality of first turn-up structures of the turn-up mechanism are arranged on the same side of the tire and arranged circumferentially along the tire, where the lead screw assembly is connected to all of the plurality of first turn-up structures to simultaneously move each of the first turn-up structures in a radial direction of the tire and roll the sidewall.

In an embodiment, when performing the step S2, the plurality of second turn-up structures of the turn-up mechanism are arranged on the other side opposite to the first turn-up structure and circumferentially along the tire, where the lead screw assembly is further connected to the plurality of second turn-up structures to simultaneously move each of the second turn-up structures in the radial direction of the tire and roll the sidewall.

According to another aspect of the present disclosure, a mechanical drum is provided, the mechanical drum is configured to perform the above-mentioned method for building a tire, and the mechanical drum includes: a spindle assembly rotationally arranged to drive the tire to rotate; a turn-up mechanism arranged on the spindle assembly to roll the sidewall; a lead screw assembly threaded in the spindle assembly and drivingly connected to the turn-up mechanism to drive the turn-up mechanism to move; and an attaching mechanism movably arranged relative to the spindle assembly to attach the bead filler and/or the sidewall to the carcass of the tire.

In an embodiment, the turn-up mechanism includes: a plurality of first turn-up structures arranged circumferentially around the spindle assembly, where the lead screw assembly is drivingly connected to the first turn-up structures to move each of the first turn-up structures simultaneously in the radial direction of the tire; and a plurality of limiting cylinders arranged and connected with the plurality of first turn-up structures in one-to-one correspondence to drive each of the first turn-up structures to press the tire.

In an embodiment, the turn-up mechanism further includes: a sleeve assembly sleeved on an outside of the spindle assembly and movably arranged along an axial direction of the spindle assembly, where a plurality of first turn-up structures are arranged around the sleeve assembly, and the lead screw assembly is drivingly connected to the sleeve assembly through a screw nut threaded in the spindle assembly to move each of the first turn-up structures.

In an embodiment, the first turn-up structure further includes: a pressure roller assembly configured to roll the sidewall of the tire; and a first drive rod assembly drivingly connected to the pressure roller assembly, where the lead screw assembly is connected to the first drive rod assembly to drive the pressure roller assembly to move in the radial direction of the tire through the first drive rod assembly.

In an embodiment, the first turn-up structure further includes: a second drive rod assembly rotationally connected to the first drive rod assembly, where the limiting cylinder is connected to the second drive rod assembly, and the pressure roller assembly is driven by the first drive rod assembly to press the tire.

In an embodiment, the turn-up mechanism further includes: a sleeve assembly movably arranged along the axial direction of the spindle assembly, where the first drive rod assembly includes a third drive rod and a fourth drive rod, and the third drive rod and the fourth drive rod are respectively rotationally connected to the sleeve assembly, and the first turn-up structure further includes: a support assembly connected to the first drive rod assembly to support the sidewall of the outer side of the turn-up mechanism; the third drive rod, the support assembly, the fourth drive rod and the sleeve assembly are in sequence connected to form a four-bar linkage.

In an embodiment, the turn-up mechanism further includes: a plurality of second turn-up structures configured to correspond to the plurality of first turn-up structures one by one and symmetrically arranged on the spindle assembly, where the lead screw assembly is further respectively drivingly connected to the second turn-up structures to simultaneously move each of the second turn-up structures in the radial direction of the tire.

According to the method for building a tire using the technical solution of the present disclosure, a part of the work of the turn-up process and the bead-filler attaching process is performed simultaneously, thereby shortening the time of the entire tire building. At the same time, in order to avoid motion interference between the two processes, the mechanical drum described below improves the structure to meet the requirements of performing a part of the work of the two specific processes simultaneously. The above method for building a tire includes: step S1: controlling the attaching mechanism to roll the bead filler to attach the bead filler to the carcass of the tire; step S2: while attaching the bead filler or during the process of attaching the bead filler, controlling the turn-up mechanism to roll the sidewall to attach the sidewall to the carcass of the tire; the above turn-up mechanism and the bead-filler attaching work are performed simultaneously, thereby improving production efficiency.

### BRIEF DESCRIPTION OF DRAWINGS

The drawings in the description, which constitute a part of the present disclosure, are used to provide a further understanding of the present disclosure. The illustrative embodiments of the present disclosure and their descriptions are used to explain the present disclosure and do not constitute an improper limitation on the present disclosure. In the figures:

FIG. 1 is a partial structural schematic diagram of a mechanical drum according to an embodiment of the present disclosure.

FIG. 2 is a partial structural schematic diagram of the turn-up mechanism of the mechanical drum according to an embodiment of the present disclosure.

The above figures include the following reference numerals:
10, Spindle assembly; 20, First turn-up structure; 21, Pressure roller assembly; 22, First drive rod assembly; 221, Third drive rod; 222, Fourth drive rod; 23, Second drive rod assembly; 24, Support assembly; 25, Lead screw nut; 30, Lead screw assembly; 40, Limiting cylinder; 50, Sleeve assembly; 60, Second turn-up structure; 70, Attaching mechanism.

### DESCRIPTION OF EMBODIMENTS

It should be noted that, in the absence of conflict, the embodiments and features in embodiments of the present disclosure may be combined with each other. The present disclosure will be described in detail below with reference to the accompanying drawings and in combination with embodiments.

In order to solve the problems of long tire building time and low building efficiency in the related art, the present disclosure provides a method for building a tire and a mechanical drum.

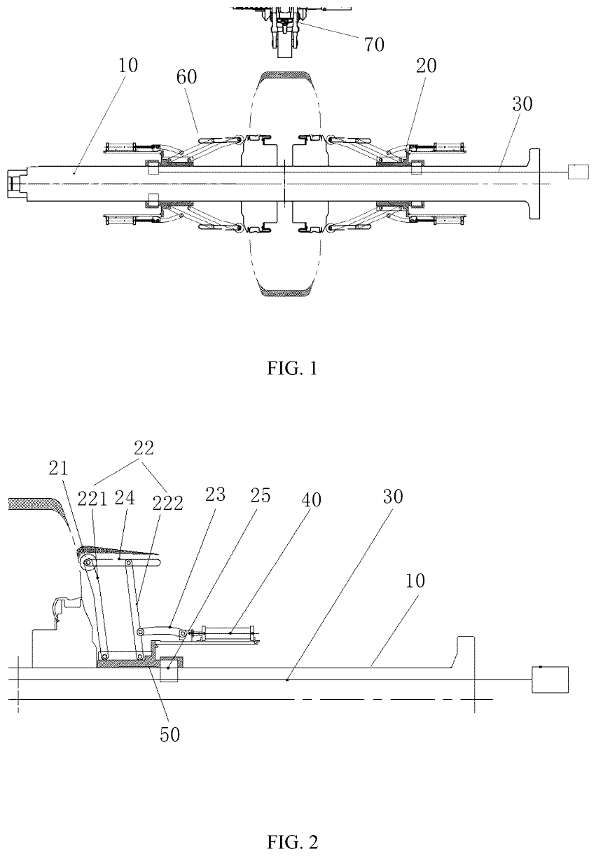

Referring to FIGS. 1 to 2, the present disclosure proposes a method for building a tire, in which part of the work of the turn-up process and the bead-filler attaching process are performed simultaneously, thereby shortening the entire tire building time. At the same time, in order to avoid motion interference between the two processes, the following mechanical drum improves the structure to meet the requirements of performing part of the work of the two processes simultaneously. Specifically, the above method for building a tire includes: step S1: controlling an attaching mechanism 70 to roll a bead filler to attach the bead filler to a carcass of the tire; step S2: while attaching the bead filler or during a process of attaching the bead filler, controlling a turn-up mechanism to roll a sidewall so as to attach the sidewall to the carcass of the tire; the above turn-up mechanism and the bead filler attaching work are performed simultaneously, thereby improving production efficiency.

In order to cooperate with the implementation of the above method, the present disclosure further provides a specific structure arrangement of a mechanical drum, which includes a spindle assembly 10, a turn-up mechanism, a lead screw assembly 30 and an attaching mechanism 70. The spindle assembly 10 adopts a hollow shaft, which can rotate the turn-up mechanism and the carcass of the tire. The turn-up mechanism is sleeved on the outside of the spindle assembly 10, and the lead screw assembly 30 is inserted into the spindle assembly 10 and is connected to the turn-up mechanism to move the turn-up mechanism; the attaching mechanism 70 is located on one side of the spindle assembly 10, which can move closer to or away from the spindle assembly 10 to attach the bead filler and/or the sidewall to the carcass of the tire.

The method for building a tire further includes step S3 after performing the step S1. The step S3: during a process of rolling, by the turn-up mechanism, the sidewall or after performing the step S2, controlling the attaching mechanism 70 to roll the sidewall to attach the sidewall to the carcass of the tire, where the turn-up mechanism and the attaching mechanism 70 roll different positions of the sidewall respectively. The turn-up mechanism is sleeved on the spindle assembly 10 and located on one side of the tire to roll the sidewall to roll one end close to a center of the tire, and the attaching mechanism 70 is arranged on the outer side of the tire in the radial direction to roll the sidewall close to the tread end of the tire.

Specifically, the turn-up mechanism includes a plurality of first turn-up structures 20 and a plurality of limiting cylinders 40, where the plurality of first turn-up structures 20 are arranged circumferentially around the spindle assembly 10, where the lead screw assembly 30 is drivingly connected to the first turn-up structure 20 to move each of first turn-up structures 20 simultaneously in the radial direction of the tire; the plurality of limiting cylinders 40 are arranged and connected with the plurality of first turn-up structures 20 in one-to-one correspondence to drive each of the first turn-up structures 20 to press the tire, and the limiting cylinders 40 cooperate with the lead screw assembly 30 to realize the function of the turn-up mechanism to roll the sidewalls along the radial direction of the carcass of the tire.

In order to enable the attaching mechanism 70 to roll the sidewalls on both sides of the tire simultaneously, the attaching mechanism 70 is symmetrically provided with two suspension arms, and the two suspension arms are driven by the same driving mechanism and can move closer or away from each other simultaneously. When the attaching mechanism 70 rolls a side surface of the tire, the two suspension arms move closer to each other and press the sidewalls against the side of the carcass of the tire so as to roll the sidewalls on both sides of the tire simultaneously.

When performing the step S2, the lead screw assembly 30 is rotated by a motor so that the pressure roller assembly 21 on the turn-up mechanism moves along the radial direction of the tire.

When performing the step S2, the pressure roller assembly 21 is driven by the limiting cylinder 40 to press the sidewall of the tire, so that the pressure roller assembly 21 always abuts against the sidewall during movement; in the existing tire building process, due to the limitations of the turn-up drive form in structure and layout, when the attaching mechanism 70 rolls the bead filler, it will interfere with the motion of the turn-up mechanism, and the problem of rolling the bead filler and the turn-up mechanism simultaneously cannot be satisfied. In order to cooperate with the implementation of this method, the present disclosure arranges the lead screw assembly on the inner side of the spindle assembly, and the lead screw assembly simultaneously moves the first turn-up structure 20 and the second turn-up structure 60 toward each other, so that the pressure roller assembly 21 moves in the radial direction of the tire. At the same time, the limiting cylinder is arranged on the spindle assembly and is driven and connected to the pressure roller assembly so that the pressure roller assembly 21 moves close to the sidewall. In order to achieve the above-mentioned movement, the first turn-up structure 20 according to the present disclosure is further provided with a pressure roller assembly 21 and a first drive rod assembly 22. The pressure roller assembly 21 is configured to roll the sidewall of the tire; the first drive rod assembly 22 is drivingly connected to the pressure roller assembly 21, and the lead screw assembly 30 is connected to the first drive rod assembly 22 to drive the pressure roller assembly 21 to move in the radial direction of the tire through the first drive rod assembly 22. The above-mentioned movement process is that the lead screw assembly 30 drives one end of the first drive rod assembly 22 to slide along the axial direction of the spindle assembly 10 through the sliding sleeve assembly 50, and the other end of the first drive rod assembly 22 swings relative to this end, so that the pressure roller assembly 21 rolls along the contour of the side surface of the carcass of the tire.

When performing the step S2, the plurality of first turn-up structures 20 of the turn-up mechanism are arranged on the same side of the tire and arranged circumferentially along the tire, where the lead screw assembly 30 is connected to the plurality of first turn-up structures 20 to simultaneously move each of the first turn-up structures 20 in a radial direction of the tire and roll the sidewall.

When performing the step S2, the plurality of second turn-up structures 60 of the turn-up mechanism are all arranged on the other side opposite to the first turn-up structure 20 and arranged circumferentially along the tire, where the lead screw assembly 30 is further connected to the plurality of second turn-up structures 60 to simultaneously move each of the second turn-up structures 60 along the radial direction of the tire and roll the sidewall. A plurality of first turn-up structures 20 form a first annular structure, and a plurality of second turn-up structures 60 form a second annular structure. The first annular structure and the second annular structure are respectively sleeved on the spindle assembly 10 and located on both sides of the carcass of the tire to respectively attach the sidewalls on both sides to the side surface of the carcass of the tire.

Since the above-mentioned lead screw assembly 30 is arranged in the spindle assembly 10, and the first turn-up structure 20 and the second turn-up structure 60 are both located on the outside of the spindle assembly 10, in order to realize the driving connection between the lead screw assembly 30 and, the first turn-up structure 20 and the second turn-up structure 60, the present disclosure opens a strip groove extending along its axial direction on the spindle assembly 10, and the sleeve assembly 50 is sleeved on an outside of the spindle assembly 10 and movably arranged along an axial direction of the spindle assembly 10, where a plurality of first turn-up structures 20 are arranged around the sleeve assembly 50, and the lead screw assembly 30 is drivingly connected to the sleeve assembly 50 through a lead screw nut 25 threaded in the spindle assembly 10 to move each of the first turn-up structure 20, where the lead screw nut 25 threads in the strip groove, and the lead screw nut 25 is connected to both the lead screw assembly 30 and the sleeve assembly 50.

The first turn-up structure 20 further includes a second drive rod assembly 23, the second drive rod assembly 23 is rotationally connected to the first drive rod assembly 22. The limiting cylinder 40 is connected to the second drive rod assembly 23, and drives, by the first drive rod assembly 22, the pressure roller assembly 21 to press the tire.

The turn-up mechanism further includes a sleeve assembly 50, the sleeve assembly 50 is movably arranged along the axial direction of the spindle assembly 10, where the first drive rod assembly 22 includes a third drive rod 221 and a fourth drive rod 222, and the third drive rod 221 and the fourth drive rod 222 are respectively rotationally connected to the sleeve assembly 50, and the first turn-up structure 20 further includes a support assembly 24, the support assembly 24 is connected to the first drive rod assembly 22 to support the sidewall of the outer side of the turn-up mechanism; the third drive rod 221, the support assembly 24, the fourth drive rod 222 and the sleeve assembly 50 are in sequence connected to form a four-bar linkage, and the connection between the first drive assembly and the second drive assembly and the pressure roller assembly 21 is realized through the arrangement of the above-mentioned linkage mechanism.

1. A method for building a tire, characterized by comprising:
step S1: controlling an attaching mechanism (70) to roll a bead filler to attach the bead filler to a carcass of the tire;
step S2: while attaching the bead filler or during a process of attaching the bead filler, controlling a turn-up mechanism to roll a sidewall so as to attach the sidewall to the carcass of the tire.

2. The method for building the tire of claim 1, further comprising step S3 after performing the step S1,
the step S3: during a process of rolling, by the turn-up mechanism, the sidewall or after performing the step S2, controlling the attaching mechanism (70) to roll the sidewall to attach the sidewall to the carcass of the tire, wherein the turn-up mechanism and the attaching mechanism (70) roll different positions of the sidewall respectively.

3. The method for building the tire of claim 2, characterized in that when performing the step S3, two suspension arms are symmetrically arranged on the attaching mechanism (70) to roll the sidewalls on both sides of the tire simultaneously.

4. The method for building the tire of claim 1, characterized in that when performing the step S2, a lead screw assembly (30) is driven to rotate by a motor so that a pressure roller assembly (21) on the turn-up mechanism moves along a radial direction of the tire.

5. The method for building the tire of claim 4, characterized in that when performing the step S2, the pressure roller assembly (21) is driven by a limiting cylinder to press the sidewall of the tire, so that the pressure roller assembly (21) always abuts against the sidewall during movement.

6. The method for building the tire of claim 4, characterized in that when performing the step S2, a plurality of first turn-up structures (20) of the turn-up mechanism are arranged on the same side of the tire and arranged circumferentially along the tire, wherein the lead screw assembly (30) is connected to the plurality of first turn-up structures (20) to simultaneously move each of the first turn-up structures (20) in a radial direction of the tire and roll the sidewall.

7. The method for building the tire of claim 6, characterized in that when performing the step S2, the plurality of second turn-up structures (60) of the turn-up mechanism are arranged on the other side opposite to the first turn-up structure (20) and circumferentially along the tire, wherein the lead screw assembly (30) is further connected to the plurality of second turn-up structures (60) to simultaneously move each of the second turn-up structures (60) in the radial direction of the tire and roll the sidewall.

8. A mechanical drum, characterized in that the mechanical drum is configured to perform the method for building the tire of claim 1, and the mechanical drum comprises:
a spindle assembly (10) rotationally arranged to drive the tire to rotate;
a turn-up mechanism arranged on the spindle assembly to roll the sidewall;
a lead screw assembly (30) threaded in the spindle assembly (10) and drivingly connected to the turn-up mechanism to drive the turn-up mechanism to move; and
an attaching mechanism (70) movably arranged relative to the spindle assembly (10) to attach the bead filler and/or the sidewall to the carcass of the tire.

9. The mechanical drum of claim 8, characterized in that the turn-up mechanism comprises:
a plurality of first turn-up structures (20) arranged circumferentially around the spindle assembly (10), wherein the lead screw assembly (30) is drivingly connected to the first turn-up structures (20) to move each of the first turn-up structures (20) simultaneously in the radial direction of the tire; and
a plurality of limiting cylinders (40) arranged and connected with the plurality of first turn-up structures (20) in one-to-one correspondence to drive each of the first turn-up structures (20) to press the tire.

10. The mechanical drum of claim 9, characterized in that the turn-up mechanism further comprises:
a sleeve assembly (50) sleeved on an outside of the spindle assembly (10) and movably arranged along an axial direction of the spindle assembly (10), wherein a plurality of first turn-up structures (20) are arranged around the sleeve assembly (50), and the lead screw assembly (30) is drivingly connected to the sleeve assembly (50) through a lead screw nut (25) threaded in the spindle assembly (10) to move each of the first turn-up structures (20).

11. The mechanical drum of claim 9, characterized in that the first turn-up structure (20) further comprises:
a pressure roller assembly (21) configured to roll the sidewall of the tire; and
a first drive rod assembly (22) drivingly connected to the pressure roller assembly (21), wherein the lead screw assembly (30) is connected to the first drive rod assembly (22) to drive the pressure roller assembly (21) to move in the radial direction of the tire through the first drive rod assembly (22).

12. The mechanical drum of claim 11, characterized in that the first turn-up structure (20) further comprises:
a second drive rod assembly (23) rotationally connected to the first drive rod assembly (22), wherein the limiting cylinder (40) is connected to the second drive rod assembly (22), and the pressure roller assembly (21) is driven by the first drive rod assembly (22) to press the tire.

13. The mechanical drum of claim 11, characterized in that the turn-up mechanism further comprises: a sleeve assembly (50) movably arranged along the axial direction of the spindle assembly (10), wherein the first drive rod assembly (22) includes a third drive rod (221) and a fourth drive rod (222), and the third drive rod (221) and the fourth drive rod (222) are respectively rotationally connected to the sleeve assembly (50), and the first turn-up structure (20) further comprises:
a support assembly (24) connected to the first drive rod assembly (22) to support the sidewall of the outer side of the turn-up mechanism;
the third drive rod (221), the support assembly (24), the fourth drive rod (222) and the sleeve assembly (50) are in sequence connected to form a four-bar linkage.

14. The mechanical drum of claim 9, characterized in that the turn-up mechanism further comprises:
a plurality of second turn-up structures (60) configured to correspond to the plurality of first turn-up structures (20) one by one and symmetrically arranged on the spindle assembly (10), wherein the lead screw assembly (30) is further respectively drivingly connected to the second turn-up structures (60) to simultaneously move each of the second turn-up structures (60) in the radial direction of the tire.
